(19) United States
(12) Patent Application Publication
(10) Pub. No.: US 2025/0155544 A1
(43) Pub. Date: May 15, 2025

(54) Estimating the Spatial Position of a Node Within a Wireless Data Network

(71) Applicant: Silvair Sp. z o.o., Kraków (PL)

(72) Inventor: Bartlomiej Piotr Slupik, Krakow (PL)

(73) Assignee: Silvair Sp. z o.o., Kraków (PL)

(21) Appl. No.: 18/937,135

(22) Filed: Nov. 5, 2024

Related U.S. Application Data
(60) Provisional application No. 63/547,854, filed on Nov. 9, 2023.
(60) Provisional application No. 63/715,549, filed on Nov. 2, 2024.

(51) Int. Cl. G01S 5/02; H04W 64/00

(52) U.S. Cl. CPC G01S 5/0289; H04W 64/003

(57) ABSTRACT

A method for a first node in a wireless data network to estimate its spatial position. The first node receives information including: an identifier of a second node, the distances between various combinations of nodes, including a third, fourth, and fifth node. The first node generates an estimate of its spatial distance to the second node, based on the content of a four-simplex that is defined by the distances between the various combinations of nodes. The first node then generates an estimate of the spatial distance between the first node and an anchor node, based on estimates of the spatial distances between the first and second node and between the second and anchor node. The first node then generates an estimate of its spatial position, based on the estimate of the spatial distance between the first node and the anchor node and the spatial position of the anchor node.

### CROSS-REFERENCES TO OTHER APPLICATIONS

This application claims the benefit of U.S. Provisional Patent Application Ser. No. 63/547,854, Attorney Docket 3015-042pr1, which is incorporated by reference herein.

This application claims the benefit of U.S. Provisional Patent Application Ser. No. 63/715,549, Attorney Docket 3015-043pr1, which is incorporated by reference herein.

### FIELD OF THE INVENTION

The present invention relates to building automation and control in general, and, more particularly, to a data-networked lighting system.

### BACKGROUND OF THE INVENTION

“Commercial building automation,” or “commercial automation,” refers to the use of computer and information technology to control commercial building systems, such as lighting, HVAC (“heating, ventilation, and air conditioning”), audio-visual, smoke detection, security, and shading, among other systems. Using specialized hardware and control logic, building devices can monitor their environment and can be controlled automatically. Although commercial automation has been available at some level of sophistication for some time, it steadily becomes more practical, from both a technological and cost perspective.

A sophisticated commercial automation and control system might include sensors (e.g., of temperature, of light, of motion or occupancy, etc.), controllers (e.g., a general-purpose personal computer, a dedicated automation controller, etc.), and actuators or actors (e.g., motorized valves, switches, etc.). The system might also include a human-machine interface device that enables an occupant of the building to interact with the system. The interface can be a specialized terminal or an application (“app”) running on a smartphone or tablet computer. The various system devices communicate over dedicated wiring, or over a wired network, or wirelessly, using one or more protocols.

Lighting automation and control systems now exist in which luminaires that comprise sensors, lamps, and control logic are networked together as “smart nodes,” in what is sometimes referred to as a “connected lighting system” or a “networked lighting control system.” In such a network, sensors which can be standalone and/or integrated into the luminaire nodes collect data about the local environment, such as data related to occupancy in the vicinity of the luminaires. The networked luminaires communicate with one another, in some cases sharing the sensor data, and adjust the light output of the lamps via the control logic, with some level of coordination across the networked luminaires.

FIG. 1 depicts connected lighting network 100 in the prior art. Network 100 is an example of a wireless networked lighting control system and comprises smart nodes 101-1 through 101-M, wherein M is a positive integer (e.g., M being equal to 5 as depicted, etc.). As depicted in FIG. 1, the nodes are luminaires (denoted by “L”). Additionally, each of the luminaires comprises an occupancy sensor unit. The networked nodes communicate wirelessly with one another via transmitted signals 102-1, 102-2, 102-3, 102-4, and 102-5. The group of nodes can be situated within a building or other structure.

Network 100 is a mesh data network that enables communication among smart nodes 101-1 through 101-M. To this end, the nodes within network 100 distribute data (e.g., the packet-based messages, etc.) in accordance with Bluetooth mesh networking. A “mesh network” is a network topology in which each node relays data for the network. The nodes that are involved cooperate in the distribution of data in the network.

Being a mesh network, network 100 is an example of a distributed control system. Distributed control systems have some advantages over centralized control systems, including in some cases the elimination of a single point of failure and the reduction of processor load. However, a mesh network by itself does not address the challenge of installing the hundreds, or thousands, of such devices on each building floor. For instance, it is necessary for a technician who is commissioning a connected lighting system to have knowledge of the connected system's topology. This includes having knowledge of where each device is within a building, among other things. But discovering the topology manually can be labor-intensive and costly.

Methods exist in the prior art for enhancing the discovery process. One category of methods is based on a multidimensional scaling (MDS) technique. However, an MDS-based technique operates centrally after having gathered data from the whole network. This is problematic when network throughput is severely limited. Other methods in the prior art are based on a distributed process, which can alleviate throughput bottlenecks. However, some such methods assume that the distance from one network node to another is equal to the sum of distances of hops on the shortest path between those nodes. Consequently, this category of prior-art methods can introduce a significant error, as the distance between two nodes is often not measured in a straight line.

Thus, what is needed is a technique for discovering the topology of a connected system, without at least some of the disadvantages and costs in the prior art.

### SUMMARY OF THE INVENTION

The present invention enables discovering the topology of a connected system of smart nodes in a data network, such as a mesh network, without at least some of the disadvantages and costs in the prior art.

In accordance with an illustrative embodiment of the present invention, a first node in a wireless data network estimates its spatial position, such as its spatial position within a building, which is unknown at this point. To do so, the first node receives information related to other nodes in the wireless data network, such as from a configuring device that is used by a technician. The information comprises: (i) an identifier of a second node, (ii) a first set of spatial distances of a third node, a fourth node, and a fifth node to one other, (iii) a second set of spatial distances of the third, fourth, and fifth node to the second node, (iv) a third set of spatial distances of the third, fourth, and fifth node to the first node, (v) an estimate of the spatial distance between the second node and an anchor node in the wireless data network, and (vi) the known spatial position of the anchor node. The first node generates an estimate of the spatial distance between the first node and the second node, based on the content of a four-simplex that is defined by the first, second, and third set of spatial distances. The estimate is obtainable without using the spatial positions of any of the first, second, third, fourth, and fifth nodes, even if the spatial positions of the other nodes are known at this point.

The first node then generates an estimate of the spatial distance between the first node and the anchor node, based on (i) the estimate of the spatial distance between the first node and the second node, (ii) the estimate of the spatial distance between the second node and the anchor node, and (iii) the content of a four-simplex that is defined by these estimates of spatial distances. The first node then generates an estimate of its spatial position, based on (i) the estimate of the spatial distance between the first node and the anchor node and (ii) the spatial position of the anchor node. The first node generates and uses estimates of the spatial distances from itself to other anchor nodes as well. The first node can transmit the estimate of its spatial position to the configuring device, which can present the results to the technician or other user.

The disclosed method provides a solution to a problem associated with at least some techniques in the prior art, including multidimensional scaling (MDS)-based techniques which operate centrally after having gathered data from the whole network. At least some MDS-based techniques require an entire distance matrix to be known prior to generating estimates of node positions. In contrast to MDS-based techniques, the disclosed method is distributed across the nodes in the data network. As a result, there is a decreased likelihood of overwhelming the data network with excess data. Additionally, each node in disclosed method only needs to use those distances between nodes that are necessary to estimate its own spatial position, instead of the system having to know most, if not all, of the distances between nodes throughout the network, thereby saving on processing resources overall.

A first illustrative method comprises: receiving, by a first node, R, in a wireless data network, information related to other nodes in the wireless data network, the information comprising: (i) an identifier of a second node, T, in the wireless data network, (ii) an identifier of a third node, G₁, in the wireless data network that is in direct communication range with the first node, (iii) a first set of spatial distances of (a) the third node, (b) a fourth node, G₂, and (c) a fifth node, G₃, in the wireless data network to one other, (iv) a second set of spatial distances of (a) the third node, (b) the fourth node, and (c) the fifth node to the second node, (v) the spatial position of a sixth node, H, in the wireless data network; measuring, by the first node in the wireless data network, distance between the first node and the third node, resulting in an estimate of the spatial distance between the first node and the third node; generating, by the first node in the wireless data network, an estimate of a spatial distance between the first node and the second node, based on (i) the first set and the second set of spatial distances and (ii) the estimate of spatial distance between the first node and the third node, wherein the spatial position of the second node is unknown to the first node; generating, by the first node in the wireless data network, an estimate of a spatial distance between the first node and the sixth node, based on the estimate of the spatial distance between the first node and the second node; generating, by the first node in the wireless data network, an estimate of the spatial position of the first node, based on (i) the estimate of the spatial distance between the first node and the sixth node and (ii) the spatial position of the sixth node; and transmitting, by the first node to a configuring device, the estimate of the spatial position of the first node.

A second illustrative method comprises: receiving, by a first node, R, in a wireless data network, information related to other nodes in the wireless data network, the information comprising: (i) an identifier of a second node, T, in the wireless data network, (ii) a first set of spatial distances of (a) a third node, G₁, (b) a fourth node, G₂, and (c) a fifth node, G₃, in the wireless data network to one other, (iii) a second set of spatial distances of (a) the third node, (b) the fourth node, and (c) the fifth node to the second node, (iv) a third set of spatial distances of (a) the third node, (b) the fourth node, and (c) the fifth node to the first node, and (v) the spatial position of a sixth node, H, in the wireless data network; generating, by the first node in the wireless data network, an estimate of a spatial distance between the first node and the second node, based on the first set, the second set, and the third set of spatial distances, wherein the spatial position of the second node is unknown to the first node; generating, by the first node in the wireless data network, an estimate of a spatial distance between the first node and a seventh node in the wireless data network, based on the estimate of the spatial distance between the first node and the second node, wherein the spatial position of the seventh node is unknown to the first node; generating, by the first node in the wireless data network, an estimate of a spatial distance between the first node and the sixth node, based on the estimate of the spatial distance between the first node and the seventh node; generating, by the first node in the wireless data network, an estimate of the spatial position of the first node, based on (i) the estimate of the spatial distance between the first node and the sixth node and (ii) the spatial position of the sixth node; and transmitting, by the first node to a configuring device, the estimate of the spatial position of the first node.

A third illustrative method comprises: receiving, by a first node, R, in a wireless data network, information related to other nodes in the wireless data network, the information comprising: (i) an identifier of a second node, T, in the wireless data network, (ii) a first set of spatial distances of (a) a third node, G₁, (b) a fourth node, G₂, and (c) a fifth node, G₃, in the wireless data network to one other, (iii) a second set of spatial distances of (a) the third node, (b) the fourth node, and (c) the fifth node to the second node, (iv) a third set of spatial distances of (a) the third node, (b) the fourth node, and (c) the fifth node to the first node, (v) an estimate of the spatial distance between the second node and a sixth node, H, in the wireless data network, and (vi) the spatial position of the sixth node; generating, by the first node in the wireless data network, an estimate of a spatial distance between the first node and the second node, based on a value of the content of a four-simplex that is defined by the first set, the second set, and the third set of spatial distances; generating, by the first node in the wireless data network, an estimate of a spatial distance between the first node and the sixth node, based on (i) the estimate of the spatial distance between the first node and the second node and (ii) the estimate of the spatial distance between the second node and the sixth node; generating, by the first node in the wireless data network, an estimate of the spatial position of the first node, based on (i) the estimate of the spatial distance between the first node and the sixth node and (ii) the spatial position of the sixth node; and transmitting, by the first node to a configuring device, the estimate of the spatial position of the first node.

### BRIEF DESCRIPTION OF THE DRAWINGS

FIG. 1 depicts connected lighting network 100 in the prior art.

FIGS. 2A and 2B depict a first and second configuration, respectively, of networked lighting control system 200 according to the illustrative embodiment.

FIG. 3 depicts the salient components of mesh device 300 according to the illustrative embodiment.

FIG. 4 depicts the salient components of configuring device 203 according to the illustrative embodiment.

FIG. 5 depicts salient operations of method 500 according to the illustrative embodiment.

FIG. 6 depicts the salient sub-operations of operation 503 for estimating the spatial distance of node 201-m to anchor j.

FIG. 7 depicts object 700, a three-dimensional solid having five points.

FIG. 8 depicts object 800, a quadrilateral having four points in three-dimensional space.

FIG. 9 depicts the salient sub-operations of operation 509 for estimating the spatial position of node 201-m.

FIG. 10 depicts salient operations of method 1000 according to the illustrative embodiment.

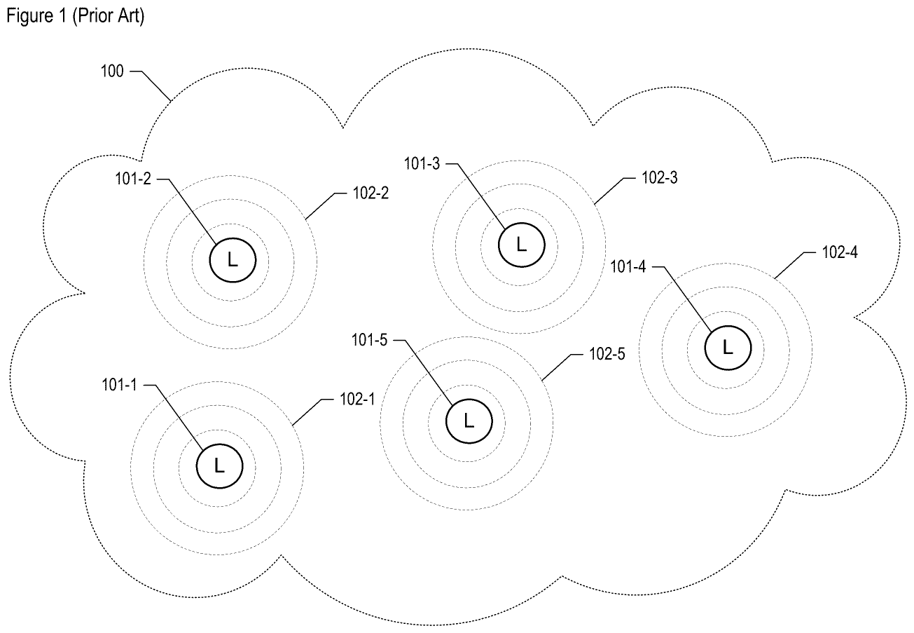

### DETAILED DESCRIPTION

Based on—For the purposes of this specification, the phrase “based on” is defined as “being dependent on” in contrast to “being independent of”. The value of Y is dependent on the value of X when the value of Y is different for two or more values of X. The value of Y is independent of the value of X when the value of Y is the same for all values of X. Being “based on” includes both functions and relations.

Distance—For the purposes of this specification, the term “distance” is defined as the amount of space (e.g., physical length, etc.) between two objects. The spatial distance can be straight-line (Euclidean) distance, distance traveled, geodesic distance, Manhattan distance, or Chebyshev distance, for example and without limitation. Unless otherwise stated, an estimate of spatial distance is an estimate of straight-line distance.

Generate—For the purposes of this specification, the infinitive “to generate” and its inflected forms (e.g., “generating”, “generated”, etc.) should be given the ordinary and customary meaning that the terms would have to a person of ordinary skill in the art at the time of the invention.

Luminaire—For the purposes of this specification, the term “luminaire” is defined as a node in a data network comprising a lamp and a controller for controlling the lamp.

Measure—For the purposes of this specification, the infinitive “to measure” and its inflected forms (e.g., “measuring”, “measured”, etc.) should be given the ordinary and customary meaning that the terms would have to a person of ordinary skill in the art at the time of the invention.

Node—For the purposes of this specification, the term “node” is defined as an electronic device that is attached to a data network, and can create, receive, and/or transmit information over a communication channel within the data network.

Adjacent Nodes—For the purposes of this specification, the term “adjacent nodes” is defined as two nodes that are within direct communication range of each other. Thus, they are capable of direct wireless communication with each other—that is, without requiring one or more intermediate nodes to relay communication. The direct communication enables, among other things, the measuring of the distance between the two adjacent nodes (e.g., through channel sounding, etc.).

Neighboring Nodes—For the purposes of this specification, the term “neighboring nodes” is defined as two nodes having spatial distances to each other that are known, either through (i) direct measurement or (ii) estimation performed in accordance with the steps disclosed herein. An adjacent node is a type of neighbor node, but a neighbor node is not necessarily an adjacent node.

Position—For the purposes of this specification, the term “position” is defined as the place where an object is located.

Receive—For the purposes of this specification, the infinitive “to receive” and its inflected forms (e.g., “receiving”, “received”, etc.) should be given the ordinary and customary meaning that the terms would have to a person of ordinary skill in the art at the time of the invention.

Transmit—For the purposes of this specification, the infinitive “to transmit” and its inflected forms (e.g., “transmitting”, “transmitted”, etc.) should be given the ordinary and customary meaning that the terms would have to a person of ordinary skill in the art at the time of the invention.

To facilitate explanation and understanding of the present invention, the following description sets forth several details. However, it will be clear to those having ordinary skill in the art, after reading the present disclosure, that the present invention may be practiced without these specific details, or with an equivalent solution or configuration. Furthermore, some structures, devices, and operations that are known in the art are depicted in block diagram form in the accompanying figures in order to keep salient aspects of the present invention from being unnecessarily obscured.

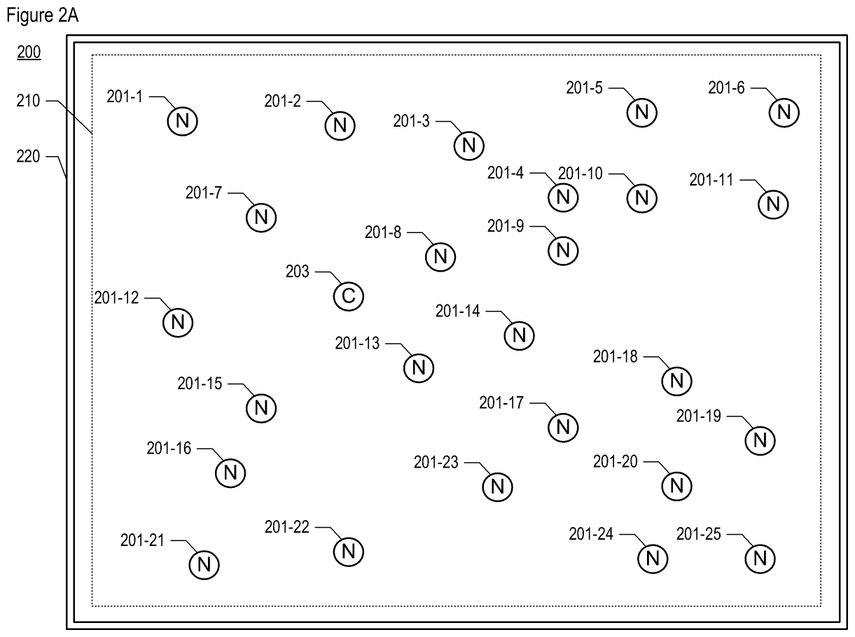

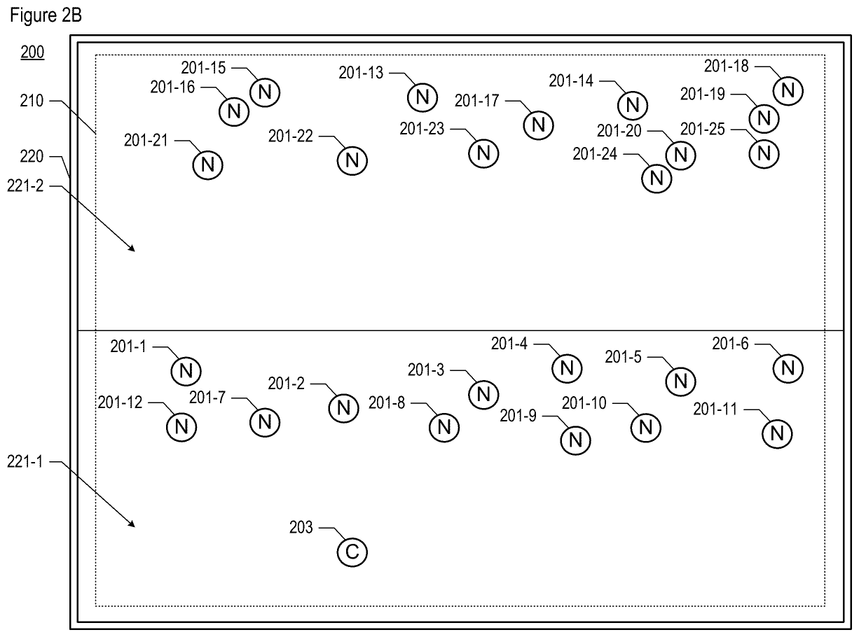

FIG. 2A depicts a first configuration of networked lighting control system 200, which comprises network nodes 201-1 through 201-M (labeled with the letter “N” for “node”), wherein M is a positive integer (e.g., M equal to 25 as depicted, etc.) situated within the depicted footprint of building 220, as viewed from above, and configuring device 203 (labeled with the letter “C” for “configuring”). Network nodes 201-1 through 201-M make up data network 210; as mesh nodes, they are provisioned devices that are, as a result, capable of operating within a mesh network. The nodes are not necessarily at the same level with respect to one another, in that they can be positioned at different heights on the same building floor of building 220.

Control system 200 is an example of a system having distributed logic. More particularly, in control system 200 of the illustrative embodiment, control functionality is distributed among the network nodes. Being equally privileged with one another, network nodes 201-1 through 201-M are peer devices to one another. With nodes 201-1 through 201-M operating as “smart nodes,” control system 200 provides a connected function such as, while not being limited to, “connected lighting” or networked “smart lighting.”

Data network 210 is a mesh network, as is known in the art, and enables communication among network nodes 201-1 through 201-M, wherein M is a positive integer (e.g., M equal to 25 as depicted, etc.). To this end, the nodes within network 210 distribute data (e.g., the packet-based messages, etc.) among one another in accordance with mesh networking. A “mesh network” is a network topology in which each node relays data for the network. The nodes that are involved cooperate in the distribution of data in the network. A mesh network can relay messages, for example, by using a flooding technique and/or a routing technique.

In accordance with the illustrative embodiment, mesh network 210 uses Bluetooth as the underlying radio technology to communicate among devices. As those who are skilled in the art will appreciate after reading this specification, network 210 can use a different radio technology than Bluetooth. The requirements to enable an interoperable mesh networking for Bluetooth wireless technology are defined in the Bluetooth Mesh Networking specifications, including the “Mesh Profile Specification,” Revision v1.0.1, Jan. 21, 2019, which is incorporated by reference herein. Additional information is defined in the “Bluetooth Core Specification,” Revision v6.0, which is incorporated by reference herein.

The Bluetooth wireless communication standard is typically employed for exchanging communications between fixed or mobile Bluetooth-enabled devices over short distances. In some configurations, the systems and methods disclosed herein may be applied to Bluetooth Low Energy (or “Bluetooth LE” or “BLE”) devices. The BLE extension of the Bluetooth standard is focused on energy-constrained applications such as battery-operated devices, sensor applications, and so on.

This description uses terminology associated with the Bluetooth and Bluetooth LE standards. As those who are skilled in the art will appreciate after reading this specification, however, the concepts can be applied to other technologies and standards that involve modulating and transmitting digital data. Such technologies and standards include, but are not limited to, Z-Wave, ZigBee, Thread, Wi-Fi, classic Bluetooth, and so on. Accordingly, while some of this description is provided in terms of Bluetooth standards, the systems and methods disclosed herein can be implemented more generally in wireless communication devices that might not conform to Bluetooth standards.

Mesh network 210 supports the Channel Sounding feature added to the Bluetooth Core Specification. Channel Sounding provides for the estimating of the distance between two Bluetooth Low Energy devices, such as nodes 201-1 through 201-M.

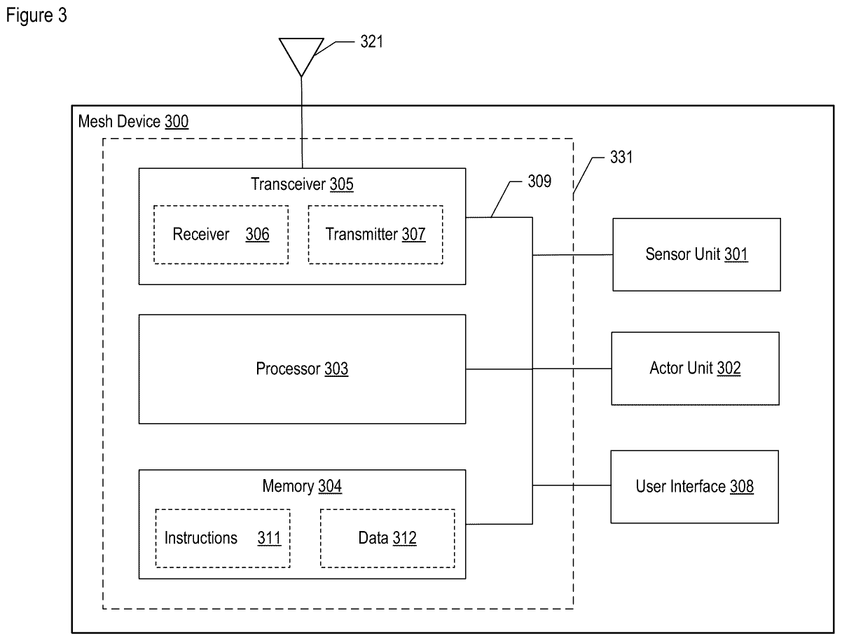

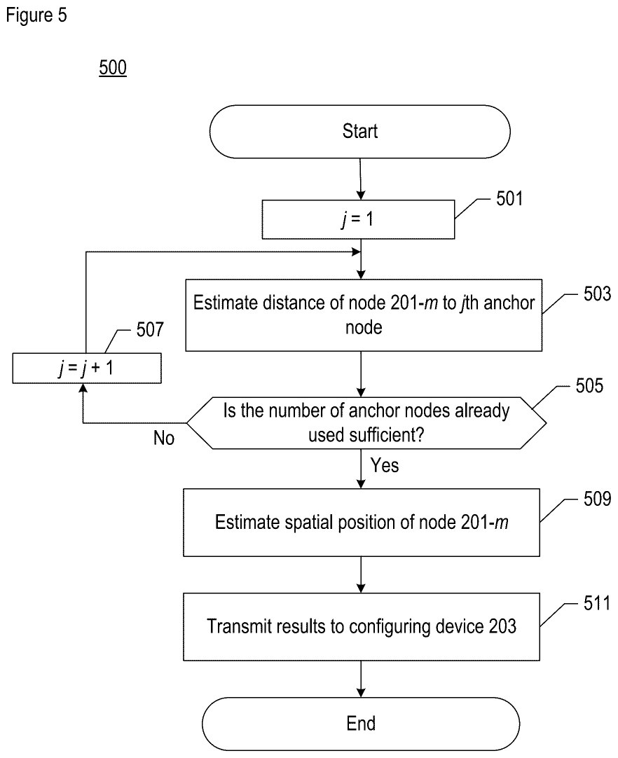

Each mesh network node 201-m (or “mesh node”), wherein m has a value between 1 and M, inclusive, is an apparatus that comprises memory, processing components, and communication components. In addition to communicating with other nodes, each mesh node can perform one or more functions, as described below. Node 201-m is described in detail below and in FIG. 3, and at least some of the operations performed by the node are described below and in FIG. 5.

Mesh node 201-m can be, or can be based on, a wireless terminal or device, a wireless transmit/receive unit (WTRU), a user equipment (UE), a mobile station, wireless handset, a fixed or mobile subscriber unit, a cellular telephone or cellphone, a smartphone, a pager, a personal digital assistant (PDA), an Internet of Things (IoT) device, an application-specific device, an access terminal, a computer, a laptop computer, a desktop computer, a tablet computer, and so on, for example and without limitation.

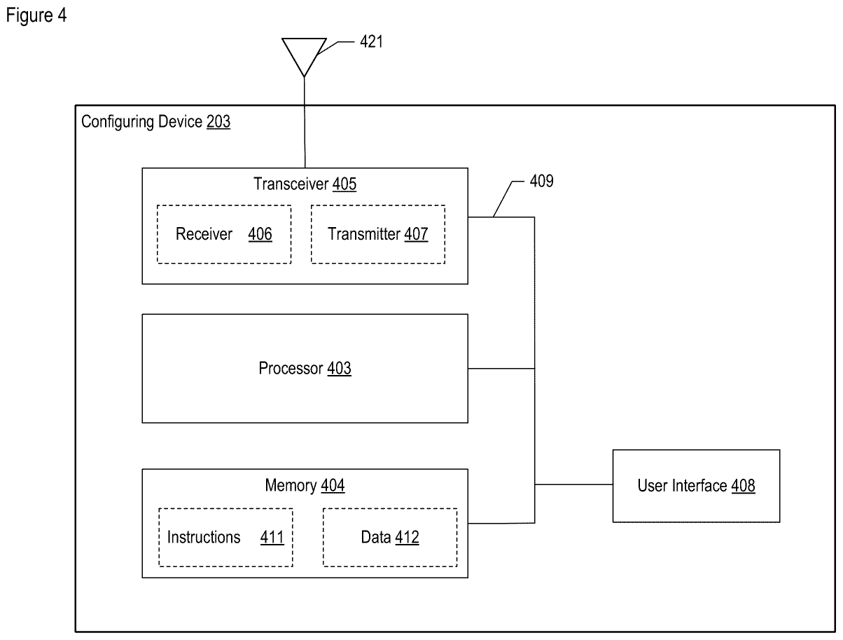

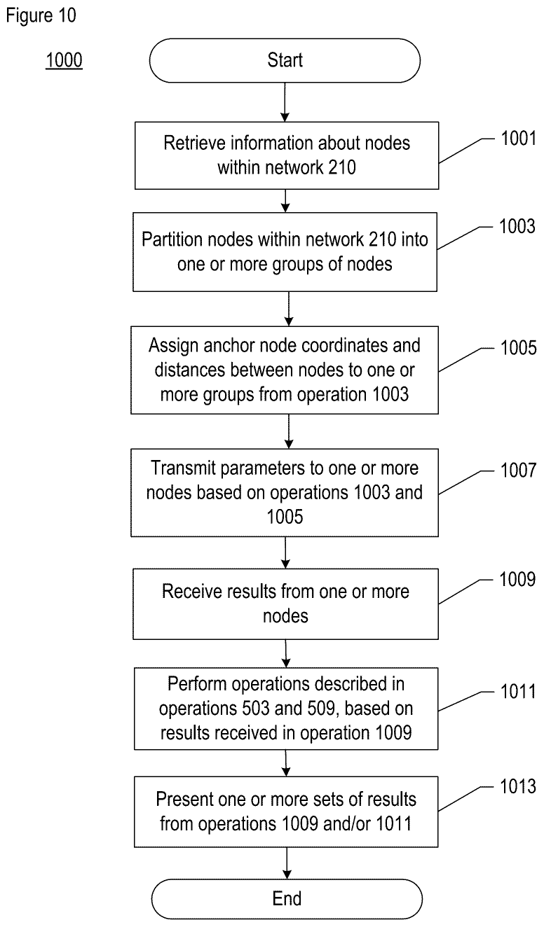

Configuring device 203 is illustratively a tablet computer with at least packet data capability provided and supported by the network in which it operates and that is configured to execute a software application (e.g., an “app”) for controlling the configuring and/or testing of one or more of mesh nodes 201-1 through 201-M. In some embodiments of the present invention, device 203 is also configured to install and provision mesh devices that, when installed and provisioned, function as mesh nodes 201-1 through 201-M. Device 203 itself, in some embodiments, can be configured to act as a mesh node as described within this specification. Configuring device 203 is described in detail below and in FIG. 4, and at least some of the operations performed by device 203 are described below and in FIG. 10.

Configuring device 203 can be, or can be based on, a wireless terminal or device, a wireless transmit/receive unit (WTRU), a user equipment (UE), a mobile station, wireless handset, a fixed or mobile subscriber unit, a cellular telephone or cellphone, a smartphone, a pager, a personal digital assistant (PDA), an Internet of Things (IoT) device, an application-specific device, an access terminal, a computer, a laptop computer, a desktop computer, a tablet computer, and so on, for example and without limitation.

In some embodiments of the present invention, device 203 comprises, or is itself, an Internet Protocol-to-Bluetooth gateway. The Internet Protocol (IP) end of the gateway function can interface to wired Ethernet, WiFi, 4G/LTE, or 5G, for example and without limitation. Device 203 is wireless in the sense that it comprises a radio (e.g., Bluetooth radio, etc.) on at least one end of its gateway function.

In accordance with the illustrative embodiment, nodes 201-1 through 201-M (“nodes 201”) are luminaires that provide lighting functionality. Each luminaire comprises a controller unit and an actor unit—in the illustrative embodiment, a luminaire with controller logic and comprising a controllable lamp as an actor unit. In some alternative embodiments, one or more of nodes 201-1 through 201-M provide a different type of functionality, in addition to or instead of lighting functionality. The networked nodes communicate wirelessly with one another via network 210.

Node 201-m is configured to transmit signals that convey control-related information, such as packet-based messages containing output control indications. Additionally, node 201-m is configured to provide light at an output that is based, at least in part, on the contents of one or more data packet messages received from one or more other luminaires (e.g., output control data messages, etc.) and/or from configuring device 203. In some alternative embodiments, node 201-m can be configured to affect a physical quantity different than light output (e.g., light color, sound level, etc.), and at an output that is based, at least in part, on the contents of one or more data packet messages received from one or more of the other mesh nodes 201-m (e.g., output control data messages, etc.) and/or from configuring device 203. A list of physical quantities that can be affected is provided below and regarding the description of actor unit 302 in FIG. 3.

In accordance with the illustrative embodiment, nodes 201 constitute an automation and control system—more specifically, a networked lighting system—in a commercial building, such as an office space or a retail space. As those who are skilled in the art will appreciate after reading this specification, however, the nodes can also be applied to a different type of building, such as a home, or to include the environment surrounding the building, or to any environment in which automated control can be applied.

Furthermore, building 220 can be a different type of structure with a roof and walls, or can instead be a defined area that comprises multiple sub-areas (e.g., open space, cubicles, one or more conference rooms, one or more corridors, one or more closed offices, etc.). At least a portion of the area and/or sub-areas can be defined by something other than a roof and/or walls (e.g., a tent, an outdoor pavilion, a covered parking lot, a stadium or arena, etc.).

As depicted in FIG. 2A, nodes 201 are positioned in an arbitrary pattern for illustrative purposes and not necessarily at the same height on the building floor. However, as those who are skilled in the art will appreciate after reading this specification, the nodes can be positioned in any geometry or geometries with respect to one another, provided that each node is within communication range of at least one of the other nodes. The nodes can be positioned on the same floor, as depicted in FIG. 2A, or on multiple floors and in any geometry across the multiple floors.

For example, FIG. 2B depicts a second configuration of network nodes 201-1 through 201-M and configuring device 203, as viewed from a side cross-section of building 220. As shown in the example, nodes 201 are divided across floors 221-1 and 222-2 within building 220. Also as shown, configuring device 203 is on floor 221-1 but can be moved to floor 222-2 as needed.

FIG. 3 depicts the salient components of mesh device 300 according to the illustrative embodiment. Device 300 is based on a data-processing apparatus whose hardware platform comprises at least some of: sensor unit 301, actor unit 302, processor 303, memory 304, transceiver 305, and user interface 308, interconnected as shown. Mesh device 300 is a device (e.g., a Bluetooth device, etc.) that is capable of being provisioned and thus becoming a mesh node and a member of mesh network 210. For example, the mesh device 300 can be provisioned as any of nodes 201-1 through 201-M of FIGS. 2A and 2B.

Various nodes within mesh network 210 can comprise different combinations of sensors, actors, processors, memory, and transceivers. For example, some nodes within mesh network 210 can comprise a controllable lamp (i.e., an actor unit), a processor, a transceiver, and, optionally, a sensor unit (e.g., for sensing occupancy, for sensing ambient light, etc.), although some such nodes might not comprise a sensor unit. As those who are skilled in the art will appreciate after reading this specification, different configurations of mesh nodes are possible, wherein each node is based on one or more of the components that are described below.

Sensor unit 301 is an apparatus that comprises memory, processing components, and communication components, and is configured to gather information about the environment that is accessible by the sensor unit. Mesh device 300 can have one or more sensor units 301, wherein each sensor is configured to monitor a particular physical quantity (e.g., temperature, illuminance of ambient lighting, humidity, motion, occupancy, etc.). For example, a first sensor unit 301 can sense occupancy measured in terms of whether someone is present or not, and might be included in some, but not necessarily all, of the nodes within mesh network 210.

Each sensor unit is configured to report a state of the physical quantity by providing input signals to processor 303, wherein the values of the input signals are representative of the states being reported. A given sensor unit 301 can report discrete input signal values and/or a continuum of states and can report states at particular times and/or continuously. A change in state, which is determined by processor 303 as described below, can occur based one or more sensor units detecting changes in the following, in any combination:
i. environmental probes (e.g., temperature, ambient light, occupancy or motion, infrared signature, humidity, air quality, sound level, etc.).
ii. electrical inputs (i.e., binary, analog, bus), including from a switch.
iii. signals received via radio (e.g., proximity beacons, etc.).
iv. a state of the internal logic, woken up periodically based on time or on an external event.

For example and without limitation, a state change can correspond to a switch being actuated, occupancy being detected, a timer or counter reaching a predetermined value, and so on.

Actor unit 302 is an apparatus that comprises memory, processing components, and communication components, and can perform a function in the course of being affected by signals originating externally to the actor component, such as from processor 303, as described in detail below. Mesh device 300 can have one or more actor units 302, wherein each actor unit acts upon its environment. In accordance with the illustrative embodiment, a first actor unit 302 is a lamp.

Actor unit 302 is configured to receive, transmit, process, and/or relay signals conveying data, as well as being configured to affect a quantity, physical or otherwise, in its environment. Actor unit 302 provides or performs a predetermined function, such as a lamp giving off light according to a configurable light output and controlled by a control signal generated by processor 303. For example and without limitation, the quantity or condition being affected can be:
i. lighting, which can be adjusted (e.g., turning on or off, changing light output, changing brightness, changing color or mood, changing illuminance, displaying a picture or pattern, etc.).
ii. sound, which can be adjusted (e.g., increasing or decreasing volume, changing playlist or mood, turning on/off, selecting signal source, etc.).
iii. room climate, which can be controlled (e.g., increasing or decreasing temperature, humidity, air fragrance, fan speed, etc.).
iv. an alert, which can be generated (e.g., of an email, of an SMS message, etc.).
v. monitoring by a camera, which can be panned or tilted.
vi. office meeting/presentation settings (e.g., selecting one or more of signal source, streaming application, multimedia to play, audio language, subtitles, chapter, play/pause/stop, rewind/fast forward, etc.).
vii. connected/smart video monitor features (e.g., selecting application to be launched, navigating through on-screen menus, etc.).
viii. virtual keyboard—navigation on virtual keyboard displayed by other device (e.g., video monitor, set-top box, etc.).
ix. control of shades/window coverings/blinds.
x. access control (e.g., unlocking/locking doors, opening/shutting doors, authorizing access to selected rooms or zones, etc.).

Furthermore, device 300 can comprise any combination of and any number of actor functions. As those who are skilled in the art will appreciate, after reading this disclosure, device 300 that comprises one or more actor functions can be in a variety of forms, such as a luminaire in a lighting system, a media player as part of an audio/video system, a heater and/or ceiling fan as part of an environment control system, an outgoing-email server as part of a messaging system, an actor in a water sprinkler system, a pump, a robot or robotic arm, a pan/tilt camera, a switch, a motor, a servo mechanism, and so on.

Processor 303 is a processing device such as a general-purpose single- or multi-chip microprocessor (e.g., an Advanced RISC [Reduced Instruction Set Computer] Machine [ARM]), a special purpose microprocessor (e.g., a digital signal processor [DSP]), a microcontroller, a programmable gate array, and so on. Processor 303 can provide control signals for one or more purposes as described in this specification.

Processor 303 is configured such that, when operating in conjunction with the other components of device 300, processor 303 executes software in the form of instructions 311, processes data in the form of data 312, and telecommunicates according to the operations described herein, including at least some of those depicted in FIG. 5 and other flow diagrams. Processor 303 can be referred to as a “central processing unit” (CPU). Although just a single processor 303 is shown as part of mesh device 300 of FIG. 3, in an alternative embodiment a combination of processors (e.g., an ARM and DSP) can be used.

Processor 303, and memory 304 and transceiver 305 described below, constitute controller unit 331. In some embodiments of the present invention, controller unit 331 is a system on a chip (SoC) such as, but not limited to, an nRF52832 integrated circuit (IC) by Nordic Semiconductor.

Memory 304 is an electronic component capable of storing electronic information and is in electronic communication with processor 303 (i.e., the processor can read information from and/or write information to the memory). Memory 304 can be configured as random-access memory (RAM), read-only memory (ROM), magnetic disk storage media, optical storage media, flash memory, on-board memory included with the processor, erasable programmable read-only memory (EPROM), electrically erasable programmable read-only memory (EEPROM), registers and so forth, including combinations thereof. At least some of memory 304 is non-transitory and non-volatile computer storage memory technology that is known in the art.

Memory 304 is configured to store an operating system, application software in the form of instructions 311, and a database in the form of data 312. The operating system is a collection of software that manages device 300's hardware resources and provides common services for computer programs, such as those that constitute the application software.

The application software that is executed by processor 303 according to the illustrative embodiment enables device 300 to perform the functions disclosed herein. Instructions 311 that constitutes the application software can include one or more programs, routines, sub-routines, functions, procedures, code, and so on. The instructions may include a single computer-readable statement or many computer-readable statements. Instructions 311 may be executable by processor 303 to implement the methods disclosed herein. Executing the instructions may involve the use of the data 312 that is stored in memory 304. Memory 304 stores one or more network addresses relevant to mesh device 300, including, but not limited to, the unicast address(es) of the mesh device and/or the group address(es) that the mesh device is subscribed to. When processor 303 executes instructions 311, various portions of the instructions can be loaded onto processor 303, and various pieces of data 312 can be loaded onto processor 303.

It will be clear to those having ordinary skill in the art how to make and use alternative embodiments that comprise more than one memory 304; or comprise subdivided segments of memory 304; or comprise a plurality of memory technologies that collectively store the operating system, application software, and database.

Radio transceiver 305, which is a communication interface, is configured to enable device 300 to telecommunicate with other devices and systems, including other mesh network nodes, by receiving signals therefrom and/or transmitting signals thereto via receiver 306 and transmitter 307, respectively. Transceiver 305 communicates in accordance with Bluetooth mesh networking. In some other embodiments, transceiver 305 communicates via one or more other radio telecommunications protocols other than or in addition to Bluetooth mesh networking, as described earlier.

Receiver 306 is a component that enables device 300 to telecommunicate with other components and systems by receiving signals that convey information therefrom and through antenna 321. It will be clear to those having ordinary skill in the art how to make and use alternative embodiments that comprise more than one receiver 306.

Transmitter 307 is a component that enables device 300 to telecommunicate with other components and systems by transmitting signals that convey information thereto and through antenna 321. It will be clear to those having ordinary skill in the art how to make and use alternative embodiments that comprise more than one transmitter 307.

In some embodiments of the present invention, transceiver 305 is implemented on hardware that is physically distinct from that of processor 303, while in some other embodiments transceiver 305 is implemented on the same hardware (IC) as processor 303.

In some embodiments of the present invention, mesh device 300 also comprises user interface 308. Interface 308 enables a user to interact with mesh device 300 and can comprise one or more of a touchscreen, a keyboard, a keypad, one or more switches or buttons, a pointing device, a display, and so on, for example and without limitation.

The various components of mesh device 300 can be electrically connected to one another by one or more buses, which may include a power bus, a control signal bus, a status signal bus, a data bus, and so on. For purposes of clarity, the various buses are illustrated collectively in FIG. 3 as bus system 309.

FIG. 4 depicts the salient components of configuring device 203 according to the illustrative embodiment. Device 203 is based on a data-processing apparatus whose hardware platform comprises at least some of: processor 403, memory 404, transceiver 405, and user interface 408, interconnected as shown. Illustratively, configuring device 203 is a tablet computer.

Processor 403 is a processing device such as a general-purpose single- or multi-chip microprocessor (e.g., an Advanced RISC [Reduced Instruction Set Computer] Machine [ARM]), a special purpose microprocessor (e.g., a digital signal processor [DSP]), a microcontroller, a programmable gate array, and so on. Processor 403 can provide control signals for one or more purposes as described in this specification.

Processor 403 is configured such that, when operating in conjunction with the other components of device 203, processor 403 executes software in the form of instructions 411, processes data in the form of data 412, and telecommunicates according to the operations described herein, including at least some of those depicted in FIG. 10 and other flow diagrams. Processor 403 can be referred to as a “central processing unit” (CPU). Although just a single processor 403 is shown as part of configuring device 203 of FIG. 4, in an alternative embodiment a combination of processors (e.g., an ARM and DSP) can be used.

Memory 404 is an electronic component capable of storing electronic information and is in electronic communication with processor 403 (i.e., the processor can read information from and/or write information to the memory). Memory 404 of device 203 is analogous to memory 304 of device 300.

Memory 404 is configured to store an operating system, application software in the form of instructions 411, and a database in the form of data 412. Memory 404 interacts with processor 403 of device 203 similarly to how memory 304 interacts with processor 303 of device 300. Additionally, instructions 411 and data 412 stored within memory 404 are analogous to instructions 311 and data 312 stored within memory 304, respectively. Thus, the same level of detail used to describe memory 304 will not be reiterated here.

Radio transceiver 405, which is a communication interface, is configured to enable device 203 to telecommunicate with other devices and systems, including other mesh network nodes, by receiving signals therefrom and/or transmitting signals thereto via receiver 406 and transmitter 407, respectively. Transceiver 405 communicates in accordance with Bluetooth mesh networking. In some other embodiments, transceiver 405 communicates via one or more other radio telecommunications protocols other than or in addition to Bluetooth mesh networking, as described earlier.

Receiver 406, transmitter 407, and antenna 421 of device 203 are analogous to receiver 306, transmitter 307, and antenna 321, respectively, of device 300. Thus, the same level of detail used to describe those components will not be reiterated here.

In some embodiments of the present invention, configuring device 203 also comprises user interface 408. Interface 408 enables a user to interact with configuring device 203 and can comprise one or more of a touchscreen, a keyboard, a keypad, one or more switches or buttons, a pointing device, a display, and so on, for example and without limitation. Device 203 uses a touchscreen or other display component of interface 408 to present information to the user, including the results of one or more tests described herein.

The various components of configuring device 203 can be electrically connected to one another by one or more buses, which may include a power bus, a control signal bus, a status signal bus, a data bus, and so on. For purposes of clarity, the various buses are illustrated collectively in FIG. 4 as bus system 409.

Overall Operations of Node 201-m: FIG. 5 depicts salient operations of method 500 according to the illustrative embodiment, by which each node 201-m performs various functions related to determining its spatial position, such as in the form of (x,y,z) coordinates in relation to a predetermined frame of reference, and to transmitting the spatial position to configuring device 203. The nodes in data network 210 correspond to vertices (vertex points) that are referred to the disclosure below. In particular, the nodes depicted in FIG. 2A are used as examples in the disclosure below and occupy different spatial positions throughout building 220, wherein one or more of the spatial positions are unknown at the start of position estimation.

An overview of the underlying position estimation algorithm is provided here. The goal is to estimate (x,y,z)-coordinate spatial positions of one or more nodes in data network 210. In the example explained here, the goal is to estimate the spatial position of node 201-8 in FIG. 2A, referred to as the “origin node” or “node R.” Initially, the only nodes having known spatial positions, each referred to as an “anchor node” or “node H,” are nodes 201-1, 201-6, 201-21, and 201-25. Anchor nodes have known, fixed spatial positions (e.g., through direct observation and measurement) and serve as anchor points in the operations described below.

There are also “adjacent nodes” within data network 210. Adjacent nodes are in direct communication range of each other and consequently can ascertain the spatial distance between each other via direct measurement. Any two adjacent nodes can measure the distance between each other, and at a known level of accuracy. For example and without limitation, node 201-8 and node 201-9 are adjacent nodes with respect to each other as they are capable of direct wireless communication, and as a result can measure their distance to each other, such as by Bluetooth channel sounding. Conversely, other nodes are out-of-range from each other, such as nodes 201-8 and 201-17, and consequently cannot directly measure the distance between each other by channel sounding. Node 201-17 is considered a “target node,” or “node T,” to node 201-8 as origin node R, as explained below.

Within data network 210 are also “neighboring nodes.” Two nodes are neighboring nodes to each other if they have spatial distances to each other that are known, either through (i) direct measurement or (ii) estimation performed in accordance with the steps disclosed herein.

To estimate the distance between two nodes that are out-of-range from each other, such as nodes 201-8 and 201-17, the following steps are applied:
i. Nodes G₁, G₂, G₃ are chosen such that they are all (a) neighboring each other, (b) neighboring an origin node R, and (c) neighboring a target node T. These nodes are referred to as “gate nodes,” and this configuration is referred to as a “gate.” Nodes 201-9, 201-14, and 201-13 are chosen as G₁, G₂, G₃, respectively. One or more of the neighboring nodes might be outside of direct communication range with each other, and thus incapable of direct measurement, even though their spatial distances to each other are known.
ii. All edge lengths of a three-dimensional solid RG₁G₂G₃T (i.e., having points R, G₁, G₂, G₃, and T) are known, at least when they need to be known in the processing, but the length between points R and T (i.e., the spatial distance between nodes 201-8 and 201-17) is unknown.

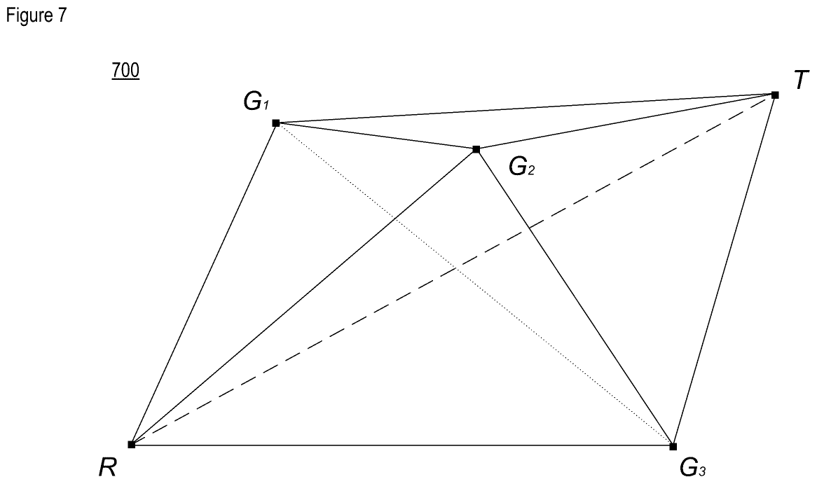

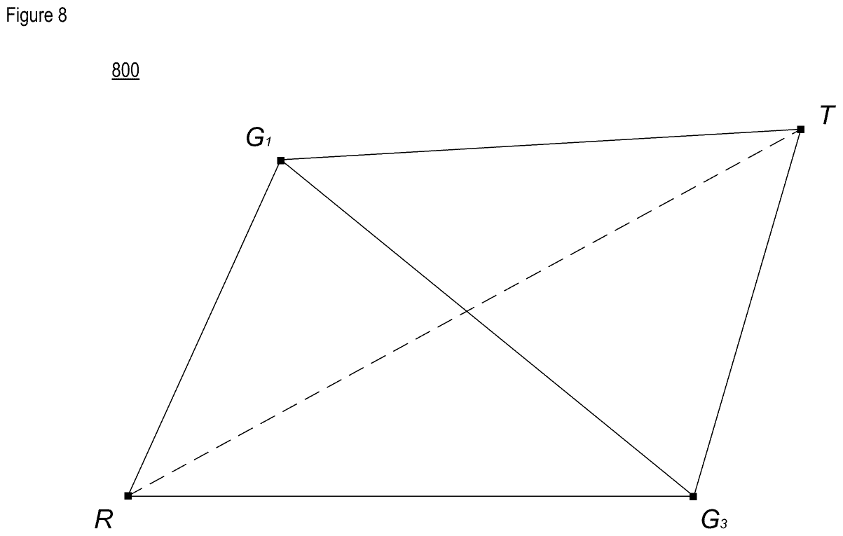

FIG. 7 depicts such a three-dimensional solid and is described in detail below. The dashed line between points R and T indicates the only unknown length out of all the lengths between the points. Points R, G₁, G₂, G₃, and T also define a “four-simplex,” as is known in the art. Given the three-dimensional nature of the method disclosed herein, points R, G₁, G₂, G₃, and Tare not necessarily at the same height on a building floor or even on the same floor.
iii. As all the points R, G₁, G₂, G₃, and T lie in the same three-dimensional space, the content of a four-simplex that they define is equal to zero. This can be thought of in a simpler way by considering four points in a three-dimensional space: they lie on the same two-dimensional plane if and only if the volume of the three-dimensional solid is zero. FIG. 8 depicts an example of the four points in three-dimensional space and is described in detail below.
iv. The content of a k-simplex can be determined given all the edge lengths, using the Cayley-Menger Determinant. No spatial position of any of the constituent nodes is necessarily known, but the configuration is known to be correct only if its four-dimensional volume is zero. As a result, a matrix equation for the distance between nodes R and T is obtained, which simplifies to a quadratic equation.
v. The equation produces two solutions, both of which are theoretically possible. Techniques are then applied to select the correct solution as described below.
vi. The afore-described steps are then repeated and/or concurrently performed on other nodes R, G₁, G₂, G₃, and T within data network 210, defining other four-simplexes to generate estimates of spatial distances between other node pairs. By using these estimates of spatial distances to define even larger four-simplexes across the nodes of data network 210, the distances between node 201-8 (node R) and subsequent target nodes T that are advancing towards an anchor node H are successively ascertained, ultimately reaching anchor node H having a known, fixed position. For example and without limitation, nodes 201-17, 201-19, 201-20, 201-24, and 201-25 can be used to form a second three-dimensional solid, and also to define a second 4-simplex, having a second set of points R, G₁, G₂, G₃, and T, respectively. As a second example, nodes 201-18, 201-19, 201-20, 201-24, and 201-25 can be used to form a third three-dimensional solid, and also to define a third 4-simplex, having a third set of points R, G₁, G₂, G₃, and T, respectively.
vii. The afore-described steps are then repeated and/or concurrently performed to generate an estimate of the spatial distance from node 201-8 (node R) to each of the other anchor nodes. For example and without limitation, with anchor node 201-6 in the processing, nodes 201-8, 201-3, 201-4, 201-9, and 201-10 can be used to form a first three-dimensional solid, and also to define a first 4-simplex, having a first set of points R, G₁, G₂, G₃, and T, respectively.
viii. Once node R knows the spatial distances to the four anchor nodes having known spatial positions (i.e., nodes 201-1, 201-6, 201-21, and 201-25), node R can determine its own spatial position, such as through a linear least squares minimization and described below.

Multiple nodes can perform the steps in method 500, concurrently and/or sequentially. Each node receives, from configuring device 203 and or from other nodes, its own information specific to the node and stage of processing that the node is in, including the node identifiers and known distance information between the nodes, anchor node information, and adjacent node information. Each non-anchor node in data network 210 determines at least its own spatial position, given that enough distances between nodes are measured or estimated and given the known spatial positions of the anchor nodes.

Regarding method 500, it will be clear to those having ordinary skill in the art, after reading the present disclosure, how to make and use alternative embodiments of the disclosed methods in which the recited operations, sub-operations, and messages are differently sequenced, grouped, or sub-divided—all within the scope of the present invention. It will be further clear to those skilled in the art, after reading the present disclosure, how to make and use alternative embodiments of the disclosed methods wherein some of the described operations, sub-operations, and messages are optional, are omitted, or are performed by other elements and/or systems than the illustrative devices associated with the respective methods.

In accordance with operation 501, node 201-m initializes its processing to estimate its spatial distance to the anchor node 1 (i.e., j=1). For illustrative purposes node 201-25 is anchor node 1.

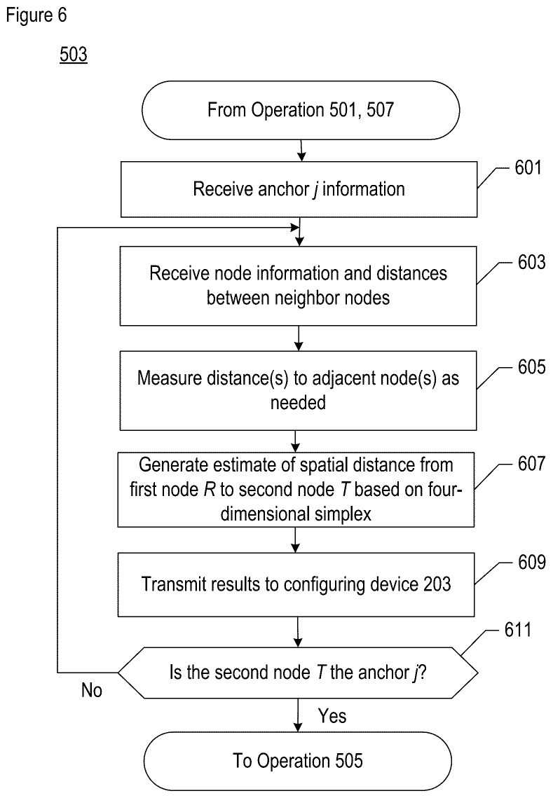

In accordance with operation 503, node 201-m estimates its spatial distance to anchor j. Operation 503 is described in detail below and regarding FIG. 6.

In accordance with operation 505, node 201-m determines whether the number of anchor nodes already used in the estimate of node 201-m's spatial position is sufficient. In some embodiments of the present invention, a minimum of four anchor nodes is required. If the number of anchor nodes already used is sufficient, then processing proceeds to operation 509. Otherwise, the next anchor node is processed, as signified by incrementing the anchor node pointer j at operation 507 and returning to operation 503 to estimate the distance of 201-m to the next anchor node—for example, anchor node 201-6, then anchor node 201-1, then anchor node 201-21.

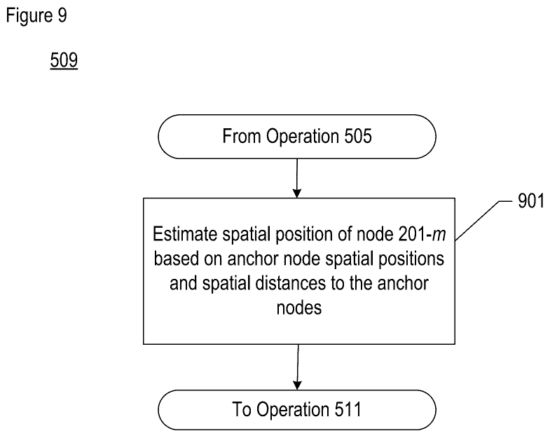

In accordance with operation 509, node 201-m estimates the spatial position of node 201-m based on (i) the estimated spatial distances of node 201-m to the anchor nodes (e.g., nodes 201-25, 201-6, 201-1, and 201-21), which are generated in accordance with operation 503, and (ii) the spatial positions of the anchor nodes, which are known in advance. Operation 509 is described in detail below and regarding FIG. 9.

In accordance with operation 511, node 201-m transmits some of or all the results from operations 503 and/or 509 to configuring device 203. In some embodiments of the present invention, instead of or in addition to transmitting to configuring device 203, node 201-m does something else with the results, such as transmitting some of or all the results to one or more of the other nodes in data network 210.

Operations of Node 201-m in Estimating the Spatial Distance of Node 201-m to Anchor j: FIG. 6 depicts the salient sub-operations of operation 503 for estimating the spatial distance of node 201-m to anchor j. For illustrative purposes, node 201-8 represents node 201-m, and node 201-25 represents anchor j. Additionally, nodes 201-8, 201-9, 201-14, 201-13, and 201-17 represent points R, G₁, G₂, G₃, T, respectively.

In accordance with operation 601, node 201-m receives information that characterizes anchor j, including an anchor node identifier and the anchor node's spatial position (e.g., its coordinates). Node 201-m can use the node identifier to keep track of the identified node in the processing, or to address and communicate with the identified node when performing a distance measurement, or both.

In accordance with operation 603, node 201-m receives information for a three-dimensional solid that includes (i) the identifiers of the solid's vertex nodes and (ii) spatial distances, if already known, between the neighbor nodes. Conceptually, node 201-m uses this information to construct a graph of the nodes and distances on which to perform the processing of the illustrative embodiment. Node 201-m can use the node identifier to keep track of the identified node in the processing, or to address or communicate with the identified node when performing a distance measurement, or both.

Node 201-m receives information from configuring device 203 describing the three-dimensional solid that the node is to process—in the illustrative example, made up of nodes 201-8, 201-9, 201-14, 201-13, and 201-17 representing points R, G₁, G₂, G₃, T, respectively. As those who are skilled in the art will appreciate after reading this specification, the set of information that node 201-m receives for estimating its distance to another node can be provided by configuring device 203 at different times, in different messages, and even from sources other than or in addition to configuring device 203 (e.g., other nodes 201).

In accordance with operation 605, node 201-m measures the distance between itself and an adjacent node or nodes, if not already known, resulting in an estimate of the spatial distance between node 201-m and the one or more adjacent nodes. For example and without limitation, node 201-8 measures the distance between itself and node 201-9, resulting in an estimate in the spatial distance between the two nodes. In accordance with the illustrative embodiment, node 201-m uses the Bluetooth channel sounding feature to measure the distance. As those who are skilled in the art will appreciate after reading this specification, however, in some embodiments of the present invention a different distance-measuring technique can be used.

In accordance with operation 607, node 201-m as a first node R, such as node 201-8, generates an estimate of spatial distance from itself to a second node T, such as node 201-17, based on a four-dimensional simplex. How the estimate is generated is explained here.

Referring to FIG. 7, the points R, G₁, G₂, G₃, T of object 700 represent a configuration of vertices needed to determine the length RT. As summarized above and regarding FIG. 5, points R, G₁, G₂, G₃, T span a configuration that can be considered as a degenerate four-simplex—in other words, the content of which equals zero because all the points lie in the same three-dimensional space.

To facilitate an understanding of simplex-based calculations, a simplified explanation involves considering three points that are on a two-dimensional plane. The three points form a triangle having a non-zero area. If the three points are then arranged in a way that they lie on the same line, the triangle degenerates into a segment, and its area becomes equal to zero.

Moving one dimension higher from the triangle, a tetrahedron can be considered. The tetrahedron has a non-zero volume; however, if its vertices are coplanar, it degenerates into a quadrilateral with its volume equal to zero. When reversing this process, a quadrilateral RG₁G₂T can be considered, which is depicted in FIG. 8 as object 800. This quadrilateral is a two-dimensional analogy of the simplex algorithm. The spatial distance between points R and T is unknown and can be estimated, given that all other spatial distances between points are known, except between points R and T as indicated by a dashed line.

Quadrilateral RG₁G₂T in FIG. 8 can also be regarded as a degenerate tetrahedron with no volume. An equation based on the Cayley-Menger determinant, as described below, can be used to determine the volume of this tetrahedron, by setting the equation to zero and solving for the unknown length RT.

The simplex algorithm disclosed herein works similarly, but one dimension higher than depicted in FIG. 8, degenerating a four-dimensional construct into a common three-dimensional space.

The content of a n-simplex can be computed using the Cayley-Menger determinant as shown in Equation 1:

$${v}_{n}^{2} = \frac{{( - 1 )}^{n + 1}}{{( n ! )}^{2} {2}^{n}} \vert \begin{matrix}0 & {d}_{01}^{2} & {d}_{02}^{2} & … & {d}_{0 n}^{2} & 1 \\ {d}_{01}^{2} & 0 & {d}_{12}^{2} & … & {d}_{1 n}^{2} & 1 \\ {d}_{01}^{2} & {d}_{12}^{2} & 0 & … & {d}_{2 n}^{2} & 1 \\ ⋮ & ⋮ & ⋮ & ⋱ & ⋮ & ⋮ \\ {d}_{0 n}^{2} & {d}_{1 n}^{2} & {d}_{2 n}^{2} & … & 0 & 1 \\ 1 & 1 & 1 & … & 1 & 0\end{matrix} \vert \qquad ( Eq . 1 )$$

where d_{XY} denotes the length, or straight-line distance, between points X and Y in general. Plugging in the known lengths and the unknown x=RT results in:

$$\vert \begin{matrix}0 & {RG}_{1} & {RG}_{2} & {RG}_{3} & {x}^{2} & 1 \\ {RG}_{1} & 0 & {G}_{1} {G}_{2} & {G}_{1} {G}_{3} & {TG}_{1} & 1 \\ {RG}_{2} & {G}_{1} {G}_{2} & 0 & {G}_{2} {G}_{3} & {TG}_{2} & 1 \\ {RG}_{3} & {G}_{1} {G}_{3} & {G}_{2} {G}_{3} & 0 & {TG}_{3} & 1 \\ {x}^{2} & {TG}_{1} & {TG}_{2} & {TG}_{3} & 0 & 1 \\ 1 & 1 & 1 & 1 & 1 & 0\end{matrix} \vert = 0 \qquad ( Eq . 2 )$$

This simplifies to a quadratic equation with variable x². As distance is always positive, the two negative roots are disregarded. The other two roots are possible distances from R to T; as shown in FIG. 7, there exists an alternative location T′ that fulfills the assumptions.

One of the solutions T and T′ is ruled out—for example, in one of the following ways:
i. The maximum signal reception range of node R is assumed to be dₘₐₓ. Consequently, if one of the solutions is less than a predetermined fraction of dₘₐₓ (for example,

$$\frac{1}{2} \cdot {d}_{max} ) ,$$

then nodes R and T would probably be within direct communication range of each other, which is contradictory to the initial assumption that nodes R and Tare not in direct communication range with each other.
ii. If both solutions are still possible, both solutions are kept for now. Later, different G₁, G₂, G₃ points are used to calculate the length RT. Doing so will produce another two solutions, and one of which—the correct solution—will be equal, or close enough, to one of the solutions from the previous calculation.

Once all combinations of points G₁, G₂, G₃, and T have been processed (by node R), the newly estimated length RT is used to form more four-simplexes, in subsequent iterations of operation 607 and with updated node information and with updated distance information between the neighbor nodes received in subsequent iterations of operation 603. For example, in a first subsequent iteration an estimated distance between nodes 201-8 and 201-17 can be used as an edge length between two points of a larger four-simplex, such as one defined by nodes 201-8, 201-18, 201-17, 201-23, and 201-20 (i.e., representing points R, G₁, G₂, G₃, T, respectively) for estimating the spatial distance between nodes 201-8 and 201-20. And in a second subsequent iteration an estimated distance between nodes 201-8 and 201-20 can be used as an edge length between two points of a larger four-simplex, such as one defined by nodes 201-8, 201-19, 201-20, 201-24, and 201-25 (i.e., representing points R, G₂, G₂, G₃, T, respectively) for estimating the spatial distance between nodes 201-8 and 201-25 (i.e., an anchor node).

As those who are skilled in art will appreciate, after reading this specification, any combination of nodes within data network 210 can be used to form three-dimensional solid RG₁G₂G₃T, and define the corresponding four-simplex, provided that the conditions defined above and regarding FIG. 5 for points R, G₁, G₂, G₃, and T are satisfied. Additionally, as those who are skilled in art will appreciate, after reading this specification, any combination of nodes within data network 210 can be used to form a subsequent three-dimensional solid RG₁G₂G₃T (and define the corresponding four-simplex) based on one or more previously-estimated lengths RT, provided that the conditions defined above and regarding FIG. 5 for points R, G₁, G₂, G₃, and Tare satisfied.

In accordance with operation 609, node 201-m transmits the results from operation 607 to configuring device 203. Additionally, configuring device 203 can share these results with one or more other nodes 201, to form larger and larger four-simplexes that ultimately reach the anchor node to which a spatial distance from node 201-m is being estimated.

In accordance with operation 611, node 201-m determines whether second node T referred to in operation 607 is anchor j—essentially, whether an estimate of the spatial distance between first node R and anchor j is now known. If not, control of task execution proceeds back to operation 603 to receive new information from configuring device 203 to process as subsequent four-simplexes representing subsequent combinations of nodes within data network 210.

Control of task execution then proceeds to operation 505.

Operations of Node 201-m in Estimating its Spatial Position: FIG. 9 depicts the salient sub-operations of operation 509, in which node 201-m estimates its spatial position based on (i) the estimated spatial distances of node 201-m to the anchor nodes, which are generated in accordance with operation 503, and (ii) the spatial positions of the anchor nodes, which are known in advance.

After completing operation 503 for anchors 1 through 4 (e.g., nodes 201-25, 201-6, 201-1, and 201-21 in data network 210), which correspond to fixed points F₁, F₂, F₃, and F₄, the distances from node R to fixed points F₁, F₂, F₃, and F₄ are known. The known spatial positions of the fixed points can have some uncertainty, so the goal is to find the most probable spatial position in accordance with operation 509. To estimate the most probable spatial position, the operations disclosed herein use matrix calculations and known information related to the anchor nodes at the known, fixed points.

In accordance with operation 901, a system of equations describing four spheres centered at points F₁ is first created:

$$\{ \begin{matrix}{d}_{1}^{2} = {( x - {x}_{1} )}^{2} + {( y - {y}_{1} )}^{2} + {( z - {z}_{1} )}^{2} \\ ⋮ \\ {d}_{4}^{2} = {( x - {x}_{4} )}^{2} + {( y - {y}_{4} )}^{2} + {( z - {z}_{4} )}^{2}\end{matrix} \qquad ( Eq . 3 )$$

Expanding each of the equations yields:

$${d}_{i}^{2} = {x}^{2} + {y}^{2} + {z}^{2} - 2 x {x}_{i} - 2 y {y}_{i} - 2 z {z}_{i} + {x}_{i}^{2} + {y}_{i}^{2} + {z}_{i}^{2} \qquad ( Eq . 4 )$$

where i=1, 2, 3, or 4.

Then, a system of three equations is created by subtracting each Equation 4 for i=2, 3, and 4 from the equation for i=1 of Equation 4. The term x²+y²+z² cancels out, leaving:

$$[ \begin{matrix}2 ( {x}_{2} - {x}_{1} ) & 2 ( {y}_{2} - {y}_{1} ) & 2 ( {z}_{2} - {z}_{1} ) \\ 2 ( {x}_{3} - {x}_{1} ) & 2 ( {y}_{3} - {y}_{1} ) & 2 ( {z}_{3} - {z}_{1} ) \\ 2 ( {x}_{4} - {x}_{1} ) & 2 ( {y}_{4} - {y}_{1} ) & 2 ( {z}_{4} - {z}_{1} )\end{matrix} ] [ \begin{matrix}x \\ y \\ z\end{matrix} ] = [ \begin{matrix}( {d}_{1}^{2} - {d}_{2}^{2} ) - ( {x}_{1}^{2} - {x}_{2}^{2} ) - ( {y}_{1}^{2} - {y}_{2}^{2} ) - ( {z}_{1}^{2} - {z}_{2}^{2} ) \\ ( {d}_{1}^{2} - {d}_{3}^{2} ) - ( {x}_{1}^{2} - {x}_{3}^{2} ) - ( {y}_{1}^{2} - {y}_{3}^{2} ) - ( {z}_{1}^{2} - {z}_{3}^{2} ) \\ ( {d}_{1}^{2} - {d}_{4}^{2} ) - ( {x}_{1}^{2} - {x}_{4}^{2} ) - ( {y}_{1}^{2} - {y}_{4}^{2} ) - ( {z}_{1}^{2} - {z}_{4}^{2} )\end{matrix} ] \qquad ( Eq . 5 )$$

which produces the solution (x,y,z) for node R as the estimate of its spatial position.

In some cases, additional nodes having known spatial positions might be available, in addition to the anchor nodes at the known, fixed points F₁, F₂, F₃, and F₄. In those cases, a method of least squares, such as linear least-squares minimization, can be used on Equation 5 to achieve the desired results.

Control of task execution then proceeds to operation 511.

Operations of Configuring Device 203: FIG. 10 depicts salient operations of method 1000 according to the illustrative embodiment, by which configuring device 203 performs various configuring-related functions related to the coordination of its own actions, as well as those of one or more mesh nodes 201-m, by determining and transmitting information to one or more of the nodes in network 210.

Regarding method 1000, it will be clear to those having ordinary skill in the art, after reading the present disclosure, how to make and use alternative embodiments of the disclosed methods in which the recited operations, sub-operations, and messages are differently sequenced, grouped, or sub-divided—all within the scope of the present invention. It will be further clear to those skilled in the art, after reading the present disclosure, how to make and use alternative embodiments of the disclosed methods wherein some of the described operations, sub-operations, and messages are optional, are omitted, or are performed by other elements and/or systems than the illustrative devices associated with the respective methods.

In accordance with operation 1001, configuring device 203 retrieves database information about nodes 201-1 through 201-M within network 210. The database describes network 210 including, among other attributes, the relationships amongst nodes 201-1 through 201-M, including their respective unicast addresses or other identifiers, known spatial positions (e.g., coordinates, etc.) of at least some of the nodes, and known distances between at least some of the nodes. The distances have been ascertained via Bluetooth channel sounding or via a different technique of a known accuracy. As those who are skilled in the art will appreciate, after reading this specification, the distances between two or more pairs of nodes can be determined later and during the processing performed by one or more nodes and in accordance with method 500 described earlier, and shared by configuring device 203 with the other nodes.

In accordance with operation 1003, configuring device 203 divides network 210 into one or more groups of nodes. The dividing is based, at least in part, on the anchor nodes and their known spatial positions and/or neighbor nodes and their known spatial distances between one another. In some embodiments of the present invention, each group of nodes corresponds to a three-dimensional solid, while in some other embodiments, each group might be further subdivided (e.g., by the nodes themselves during processing in accordance with method 500, etc.) into multiple three-dimensional solids.

In accordance with operation 1005, configuring device 203 assigns anchor node spatial positions and distances between nodes to one or more groups created in operation 1003.

In accordance with operation 1007, configuring device 203 transmits parameters (e.g., group identifiers, node addresses and/or identifiers for each group, anchor spatial positions, node-pair distances, etc.) assigned to one or more nodes 201 in network 210 based on values determined in operations 1003 and 1005. Each of the nodes uses the parameters transmitted to them to perform one or more operations in method 500.

In accordance with operation 1009, configuring device 203 receives results from one or more nodes 201 in network 210.

In accordance with operation 1011, configuring device 203 optionally performs steps similar to those described in operations 503 and 509, based on database information retrieved in operation 1001 and/or results received in operation 1009. For example, in some configurations it might be advantageous for configuring device 203 to determine the spatial positions of one or more nodes 201, instead of the nodes themselves determining their spatial positions.

In accordance with operation 1013, configuring device 203 presents (e.g., displays, etc.) to the user at least some of the results of the position estimation process from operation 1009 and/or 1011. For example and without limitation, device 203 can present any or all of the spatial positions (e.g., coordinates, etc.) of the nodes within the area of interest, their relative positions to one another based on the estimated spatial positions of one or more of the nodes, their relative positions to one or more of the anchor nodes, and/or their distances between one another, and/or any intermediate information disclosed herein that is used to generate one or more estimates of node position(s). Device 203 can present any or all of this information on a map (e.g., floor plan or plans, etc.), in a list, or in any other format, such as on user interface 408. Device 203 can store any or all of this information (e.g., in a configuration database, etc.).

Moreover, device 203 can transmit any or all of the foregoing information to a different data-processing system, such as to a gateway, to a configuration database in the Cloud, and so forth, and for various reasons (e.g., storage, processing, presentation to a user, etc.).

In some embodiments of the present invention, configuring device 203 repeats some of or all the afore-described operations of method 1000 until the spatial positions of one or more nodes 201 are known. As those who are skilled in art will appreciate, after reading this specification, configuring device 203 can transmit additional sets of information as needed in a subsequent iteration of operation 1007, based in part on the results received in the current iteration's operation 1009. Each of these additional sets of information can include any combination of nodes within data network 210 to form three-dimensional solid RG₁G₂G₃T, and define the corresponding four-simplex, provided that the conditions defined above and regarding FIG. 5 for points R, G₁, G₂, G₃, and Tare satisfied.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, flash storage, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, Blu-ray™ disc, and Ultra HD disc where disks usually reproduce data magnetically, while discs reproduce data optically with lasers.

It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), flash storage, read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving, by a first node, R, in a wireless data network, information related to other nodes in the wireless data network, the information comprising:
(i) an identifier of a second node, T, in the wireless data network,
(ii) an identifier of a third node, G₁, in the wireless data network that is in direct communication range with the first node,
(iii) a first set of spatial distances of (a) the third node, (b) a fourth node, G₂, and (c) a fifth node, G₃, in the wireless data network to one other,
(iv) a second set of spatial distances of (a) the third node, (b) the fourth node, and (c) the fifth node to the second node,
(v) the spatial position of a sixth node, H, in the wireless data network;
measuring, by the first node in the wireless data network, distance between the first node and the third node, resulting in an estimate of the spatial distance between the first node and the third node;
generating, by the first node in the wireless data network, an estimate of a spatial distance between the first node and the second node, based on (i) the first set and the second set of spatial distances and (ii) the estimate of spatial distance between the first node and the third node, wherein the spatial position of the second node is unknown to the first node;
generating, by the first node in the wireless data network, an estimate of a spatial distance between the first node and the sixth node, based on the estimate of the spatial distance between the first node and the second node;
generating, by the first node in the wireless data network, an estimate of the spatial position of the first node, based on (i) the estimate of the spatial distance between the first node and the sixth node and (ii) the spatial position of the sixth node; and
transmitting, by the first node to a configuring device, the estimate of the spatial position of the first node.

2. The method of claim 1, wherein the estimate of the spatial distance between the first node and the second node is based on a value of the content of a four-simplex that is defined by (i) the first set, the second set, and the third set of spatial distances and (ii) the estimate of spatial distance between the first node and the third node.

3. The method of claim 1, wherein the fourth node is within direct communication range of the first node, and further comprising:
measuring, by the first node in the wireless data network, distance between the first node and the fourth node, resulting in an estimate of the spatial distance between the first node and the fourth node.

4. The method of claim 1 further comprising:
measuring, by the third node in the wireless data network, distance between the second node and the third node, resulting in an estimate of the spatial distance between the second node and the third node; and
transmitting, by the third node to one of (i) the first node and (ii) the configuring device, the estimate of the spatial distance between the second node and the third node.

5. The method of claim 1 further comprising:
measuring, by the third node in the wireless data network, distance between the third node and the fourth node, resulting in an estimate of the spatial distance between the third node and the fourth node; and
transmitting, by the third node to one of (i) the first node and (ii) the configuring device, the estimate of the spatial distance between the fourth node and the third node.

6. The method of claim 1 further comprising:
generating, by the first node in the wireless data network, an estimate of a spatial distance between the first node and a seventh node in the wireless data network, based on the estimate of the spatial distance between the first node and the second node, wherein the spatial position of the seventh node is unknown to the first node;
wherein the estimate of the spatial distance between the first node and the sixth node is further based on the estimate of the spatial distance between the first node and the seventh node.

7. The method claim 6 further comprising:
generating, by the second node in the wireless data network, an estimate of a spatial distance between the second node and the seventh node, based on a value of the content of a four-simplex that is defined in part by the spatial distances (i) between the second node and three gate nodes in the wireless data network and (ii) between the three gate nodes and the seventh node, wherein the spatial position of the seventh node is unknown to the second node;
wherein the estimate of the spatial distance between the first node and the seventh node is further based on the estimate of the spatial distance between the second node and the seventh node.

8. The method of claim 1, wherein the generating of the estimate of the spatial position of the first node is further based on (i) a method of least squares and (ii) the spatial position of at least one additional node in the wireless data network.

9. The method of claim 1 further comprising:
receiving, by the configuring device, the estimate of the spatial position of the first node; and
displaying, by the configuring device, relative positions of the first node and sixth node, based on (i) the estimate of the spatial position of the first node and (ii) the spatial position of the sixth node.

10. A method comprising:
receiving, by a first node, R, in a wireless data network, information related to other nodes in the wireless data network, the information comprising:
(i) an identifier of a second node, T, in the wireless data network,
(ii) a first set of spatial distances of (a) a third node, G₁, (b) a fourth node, G₂, and (c) a fifth node, G₃, in the wireless data network to one other,
(iii) a second set of spatial distances of (a) the third node, (b) the fourth node, and (c) the fifth node to the second node,
(iv) a third set of spatial distances of (a) the third node, (b) the fourth node, and (c) the fifth node to the first node, and
(v) the spatial position of a sixth node, H, in the wireless data network;
generating, by the first node in the wireless data network, an estimate of a spatial distance between the first node and the second node, based on the first set, the second set, and the third set of spatial distances, wherein the spatial position of the second node is unknown to the first node;
generating, by the first node in the wireless data network, an estimate of a spatial distance between the first node and a seventh node in the wireless data network, based on the estimate of the spatial distance between the first node and the second node, wherein the spatial position of the seventh node is unknown to the first node;
generating, by the first node in the wireless data network, an estimate of a spatial distance between the first node and the sixth node, based on the estimate of the spatial distance between the first node and the seventh node;
generating, by the first node in the wireless data network, an estimate of the spatial position of the first node, based on (i) the estimate of the spatial distance between the first node and the sixth node and (ii) the spatial position of the sixth node; and
transmitting, by the first node to a configuring device, the estimate of the spatial position of the first node.

11. The method of claim 10, wherein the estimate of the spatial distance between the first node and the second node is based on a value of the content of a first four-simplex that is defined by the first set, the second set, and the third set of spatial distances.

12. The method of claim 11, wherein the generating of the estimate of the spatial distance between the first node and the second node is further based on the value of the content of the first four-simplex being equal to zero.

13. The method of claim 10 further comprising:
generating, by the second node in the wireless data network, an estimate of a spatial distance between the second node and the seventh node, based on a value of the content of a second four-simplex that is defined in part by the spatial distances between (i) between the second node and three gate nodes in the wireless data network and (ii) between the three gate nodes and the seventh node, wherein the spatial position of the seventh node is unknown to the second node;
wherein the estimate of the spatial distance between the first node and the seventh node is further based on the estimate of the spatial distance between the second node and the seventh node.

14. The method of claim 10 further comprising:
receiving, by the configuring device, the estimate of the spatial position of the first node; and
displaying, by the configuring device, relative positions of the first node and sixth node, based on (i) the estimate of the spatial position of the first node and (ii) the spatial position of the sixth node.

15. A method comprising:
receiving, by a first node, R, in a wireless data network, information related to other nodes in the wireless data network, the information comprising:
(i) an identifier of a second node, T, in the wireless data network,
(ii) a first set of spatial distances of (a) a third node, G₁, (b) a fourth node, G₂, and (c) a fifth node, G₃, in the wireless data network to one other,
(iii) a second set of spatial distances of (a) the third node, (b) the fourth node, and (c) the fifth node to the second node,
(iv) a third set of spatial distances of (a) the third node, (b) the fourth node, and (c) the fifth node to the first node,
(v) an estimate of the spatial distance between the second node and a sixth node, H, in the wireless data network, and
(vi) the spatial position of the sixth node;
generating, by the first node in the wireless data network, an estimate of a spatial distance between the first node and the second node, based on a value of the content of a four-simplex that is defined by the first set, the second set, and the third set of spatial distances;
generating, by the first node in the wireless data network, an estimate of a spatial distance between the first node and the sixth node, based on (i) the estimate of the spatial distance between the first node and the second node and (ii) the estimate of the spatial distance between the second node and the sixth node;
generating, by the first node in the wireless data network, an estimate of the spatial position of the first node, based on (i) the estimate of the spatial distance between the first node and the sixth node and (ii) the spatial position of the sixth node; and
transmitting, by the first node to a configuring device, the estimate of the spatial position of the first node.

16. The method of claim 15, wherein the generating of the estimate of the spatial distance between the first node and the second node is further based on the value of the content of the four-simplex being equal to zero.

17. The method of claim 15 further comprising:
measuring, by the third node in the wireless data network, distance between the first node and the third node, resulting in an estimate of the spatial distance between the first node and the third node; and
transmitting, by the third node to one of (i) the first node and (ii) the configuring device, the estimate of the spatial distance between the first node and the third node, wherein the four-simplex is further defined by the estimate of the spatial distance between the first node and the third node.

18. The method of claim 15 further comprising:
measuring, by the third node in the wireless data network, distance between the third node and the fourth node, resulting in an estimate of the spatial distance between the third node and the fourth node; and
transmitting, by the third node to one of (i) the first node and (ii) the configuring device, the estimate of the spatial distance between the third node and the fourth node, wherein the four-simplex is further defined by the estimate of the spatial distance between the third node and the fourth node.

19. The method of claim 15, wherein the generating of the estimate of the spatial position of the first node is further based on (i) a method of least squares and (ii) the spatial position of at least one additional node in the wireless data network.

20. The method of claim 15 further comprising:
receiving, by the configuring device, the estimate of the spatial position of the first node; and
displaying, by the configuring device, relative positions of the first node and sixth node, based on (i) the estimate of the spatial position of the first node and (ii) the spatial position of the sixth node.
